(19) United States
(12) Patent Application Publication
(10) Pub. No.: US 2005/0190966 A1
(43) Pub. Date: Sep. 1, 2005

(54) Self-contained integrated color processing imager

(76) Inventors: Ralph R. Etienne-Cummings, Washington, DC (US); M. Anthony Lewis, Mahomet, IL (US); Philippe O. Pouliquen, Baltimore, MD (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/118,485

(22) Filed: May 2, 2005

Related U.S. Application Data
(63) Continuation-in-part of application No. 10/214,123, filed on Aug. 8, 2002, now Pat. No. 6,897,426.

(51) Int. Cl. G06K 9/60; G06K 9/80; G06T 7/00; H04N 1/48; H04N 9/04; H04N 3/14

(52) U.S. Cl. 382/165; 382/209; 382/312; 382/167; 348/272; 358/513

(57) ABSTRACT

An imaging array is integrated with region of interest selection, template storage and processing circuitry for transforming raw image data for respective pixels in terms of defined color opponencies and analyzing (e.g. by histogramming or the like) the transformed image data over respective regions of interest of arbitrary size to extract color signatures of portions of a scene. The color signatures may then be compared to templates for object recognition, tracking or other purposes.

### CROSS-REFERENCE TO RELATED APPLICATIONS

This application is a Continuation-in-Part of U.S. patent application Ser. No. 10/214,123, filed Aug. 8, 2002, priority of which as to common subject matter with the present application is hereby claimed and the entire disclosure thereof is hereby fully incorporated by reference.

### BACKGROUND OF THE INVENTION

1. Field of the Invention

This invention is related to color image sensors and, more particularly, to color integrated image sensors including image processing circuitry for information extraction integrated therewith.

2. Description of the Prior Art

CMOS integrated circuits technology readily allows the incorporation of photodetector arrays and image processing circuits on the same silicon die. This has led to the recent proliferation in cheap and compact digital cameras, system-on-a-chip video processors, and many other cutting-edge commercial and research imaging products. The concept of using CMOS technology for combining sensing and processing was not spear-headed by the imaging community. It actually emerged in mid 1980's from the neuromorphic engineering community, developed by Carver Mead and collaborators, as discussed in “Sensitive Electronic Photoreceptors” by C. Mead, Proc. 1985 Chapel Hill Conf. VLSI, pp. 463-471, Computer Science Press, Maryland, 1984. Mead's motivation was to mimic the information processing capabilities of biological organisms; biology tends to optimize information extraction by introducing processing at the sensing epithelium. This approach to sensory information processing, which was later captured with terms such as “sensory processing” and “computational sensors,” produced a myriad of vision chips, whose functionalities include edge detection, motion detection, stereopsis and many others (examples can be found in “Neuromorphic Electronic Systems” by C. Mead, Proc. IEEE, Vol 78, pp. 1629-1636, 1990).

The preponderance of the work on neuromorphic vision has focused on spatiotemporal processing on the intensity of light (gray scale images) because the intensity can be readily transformed into a voltage or current using basic integrated circuits components: photodiodes, photogates, and phototransistors. These devices are easily implemented in CMOS technologies using no additional lithography layers. On the other hand, color image processing has been limited primarily to the commercial camera arena because three additional masks are required to implement red (R), green (G) and blue (B) filters. The additional masks make fabrication of color sensitive photodetection arrays expensive and, therefore, not readily available to researchers. Nonetheless, a large part of human visual perception is based on color information processing. Consequently, neuromorphic vision systems should not ignore this obviously important cue for scene analysis and understanding.

There has been a limited amount of previous work on neuromorphic color processing. The vast majority of color processing literature addresses standard digital image processing techniques. That is, they consist of a camera that is connected to a frame-grabber that contains an analog-to-digital converter (ADC). The ADC interfaces with a digital computer, where software algorithms are executed. Of the few biologically inspired hardware papers, there are clearly two approaches. The first approach uses separate imaging chips and processing chips discussed in “A real-Time Neural System for Color Constancy” by A. Moore et al., IEEE Transactions on Neural Networks, Vol. 2, No. 2, pp. 237-247, 1991, while the second approach integrates a handful of photodetectors and analog processing circuitry as discussed in “Towards Color Image Segmentation in analog VLSI: Algorithms and Hardware” by F. Perez et al., Int. J. Computer Vision, Vol. 12, No. 1, pp.17-42, 1994. In the former example, standard cameras are connected directly to analog VLSI chips that demultiplex the video stream and store the pixel values as voltages on arrays of capacitors. Arrays as large as 50×50 pixels have been realized to implement various algorithms for color constancy as noted in Moore et al., cited above. As can be expected, the system is large and clumsy, but real-time performance is possible. The second set of chips investigate a particular biologically inspired problem, such as RGB (red, green, blue color)-to-HSI (Hue, Saturation and Intensity) conversion using biologically plausible color opponents and HSI-based image segmentation, using a very small number of photodetectors and integrated analog VLSI circuits as noted in Perez et al., cited above. Clearly, the goal of the latter is to demonstrate a concept and not to develop a practical system for useful image sizes.

One persistent problem in attempts at neuromorphic color processing is encountered in seeking to model a degree of subjectivity in human color perception, particularly in regard to color temperature of illumination of objects or a scene. For example, a human observer will tend to perceive the same color of an object regardless of whether it is illuminated by direct sunlight, indirect light from the sky, incandescent light, etc. (although some differences in color perception may occur under fluorescent illumination or other illumination having strong, narrow peaks in the light spectrum such as mercury vapor illumination). It has been hypothesized that human language encodes particular colors into broad linguistic categories corresponding to about eleven basic colors which are fairly stable in regard to color temperature variation of illumination. In contrast, machine vision system are extremely sensitive to changes in the spectral content of light and small changes in illumination may cause large shifts in apparent color detected by an imager which, in turn, leads to errors in any form of image processing which relies on color matching.

### SUMMARY OF THE INVENTION

It is therefore an object of the present invention to to address the gap in the silicon vision literature by providing an integrated, large-array of color photodetectors and on-chip processing.

It is another object of the invention to provide an integrated chip for the recognition of objects based on their color signatures.

It is a further object of the invention to provide a color image sensor integrated together with image processing circuitry sufficient to support information extraction on a single chip.

It is yet another object of the invention to provide a generalized, rule-based processing embodiment for extraction of color signatures from raw image data which can also be integrated with an image sensor array on an integrated circuit chip.

It is yet another object of the invention to provide image processing which tends to emulate human insensitivity to color temperature variation which can be integrated on a single chip with a color imaging array.

In order to accomplish these and other objects of the invention, a color-based visual sensor is provided, comprising a sensor array for sensing component colors of light in a scene and providing image data in accordance with an arbitrary color space, an arrangement for defining opponencies in the color space, a processor for transforming said image data in accordance with the opponencies to provide transformed image data, comparators for dividing the transformed image data into families and sub-families in accordance with respective opponencies and combinations of opponencies, respectively, and for dividing the families and subfamilies in accordance with variation of the transformed image data corresponding to respective opponencies to produce divided transformed image data, registers for region of interest selection, an analyzer for analyzing the divided transformed image data over the region of interest to develop a color signature, and a calculator for matching the color signature with a template.

### BRIEF DESCRIPTION OF THE DRAWINGS

The foregoing and other objects, aspects and advantages will be better understood from the following detailed description of a preferred embodiment of the invention with reference to the drawings, in which:

FIGS. 1A and 1B are a block diagram of a chip in accordance with the invention and a chip layout diagram, respectively,

FIGS. 2A and 2B are a schematic diagram of the pixel circuit and a schematic diagram of the normalization circuit, respectively,

FIGS. 3A and 3B are a schematic of a saturation circuit in accordance with a preferred embodiment of the invention and a hue look-up table, respectively,

FIGS. 4A and 4B illustrate a pixel segmentation of a test image in accordance with a preferred (hue-based) embodiment of the invention,

FIGS. 5A and 5B illustrate template learning and matching,

FIG. 6 is a diagram useful for understanding opponency in regard to an arbitrary color space, and

FIG. 7 is a diagram useful for understanding the application of rule sets to opponency-transformed image data for extracting a color signature.

### DETAILED DESCRIPTION OF A PREFERRED EMBODIMENT OF THE INVENTION

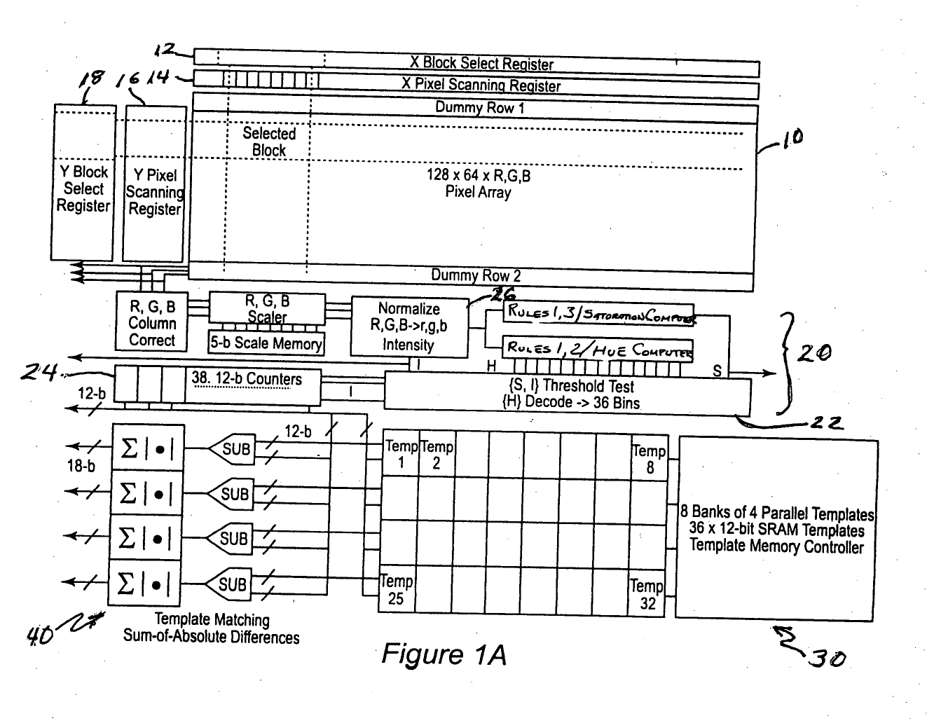

Referring now to the drawings, and more particularly to FIGS. 1A and 1B, a RGB CMOS imager 10, preferably of dimensions of 128 pixels horizontally and 64 pixels vertically, is integrated with mixed signal processing circuitry 12, 14, 16, 18 to realize focal-plane region-of-interest selection and scanning, RGB-to-HSI transformation 20, HSI-based segmentation 22, 36-bins HSI histogramming 24 and sum-of-absolute-difference (SAD) template matching 30, 40. (It should be appreciated that FIGS. 1A and 1B have substantially the same content but FIG. 1 emphasizes the cooperation of elements and functional blocks therein while FIG. 1B emphasizes a preferred layout on a single chip.) This self-contained color imaging and processing chip, designed as a front-end for micro-robotics, toys and “seeing-eye” computers, learns the identity of specially coded color objects through their color signature. The signature is preferably composed of a 36-bins×12-bits histogram template, preferably using an HSI color space. The template is stored at the focal-plane during a learning step. During the recognition step, newly acquired images are compared to 32 stored templates using a SAD computer. The minimum SAD result indicates the closest match. In addition, the chip can be used to segment a color image and identify regions in the scene having particular color characteristics. The location of the matched regions can be used to track objects in the environment. Table I shows the specifications of the chip, which, of course, may be varied within the spirit and scope of the invention and foreseeable advances in the current state of the art.

TABLE I

| | |
|---|---|
| Technology | 0.5 μm 3M CMOS |
| Array size | 128 (H) × 64 (V) |
| Chip Area | 4.25 mm × 4.25 mm |
| Pixel size | 24.85 μm × 24.85 μm |
| Fill factor | 20% |
| FPN | ˜5% |
| Dynamic Range | 120 db (current range |
| Region-of-interest size | 1 × 1 to 128 × 64 |
| Color current scaling | 4 bits |
| Hue bins | 36, each 10° wide |
| Saturation | Analog (˜5 bits) one threshold |
| Intensity | Analog (˜5 bits) one threshold |
| Histogram bin counts | 12 bits/bin |
| Template size | 432 bits (12 × 36 bits) |
| No. of stored templates | 32 (13.8 Kbits SRAM) |
| Template matching | 4 parallel SAD, 18 bits results |
| Frame rate | Array scan ˜2K fbs, |
| | HIS comp ˜30 fps |
| Power consumption | ˜1 mW @ 30 fps on 3.3 V supply |

This chip represents the first self-contained color processing imager with focal-plane segmentation, histogramming and template matching capabilities. The principal functional blocks of this chip combining an imager and image information extraction circuitry will now be described.

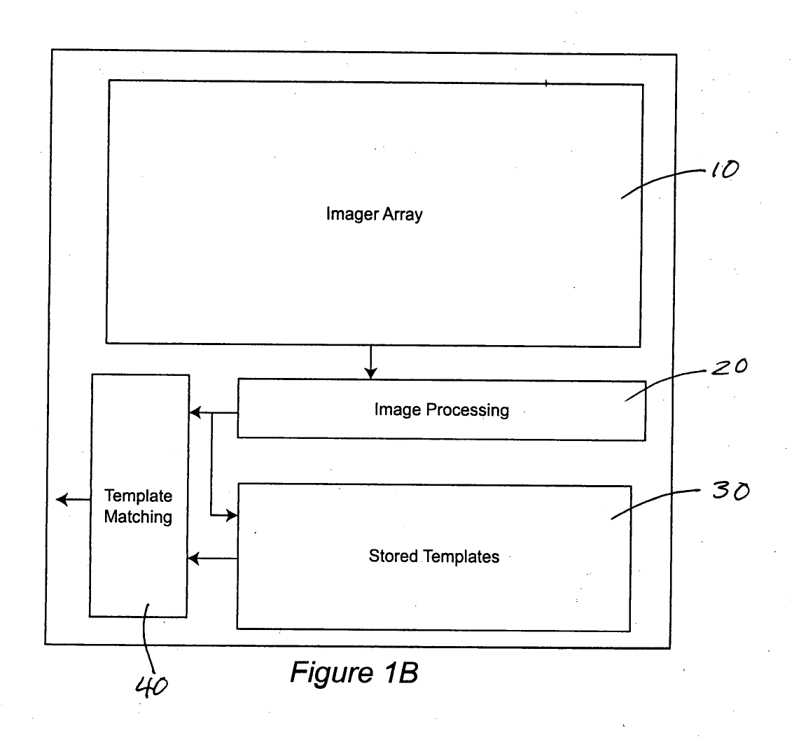

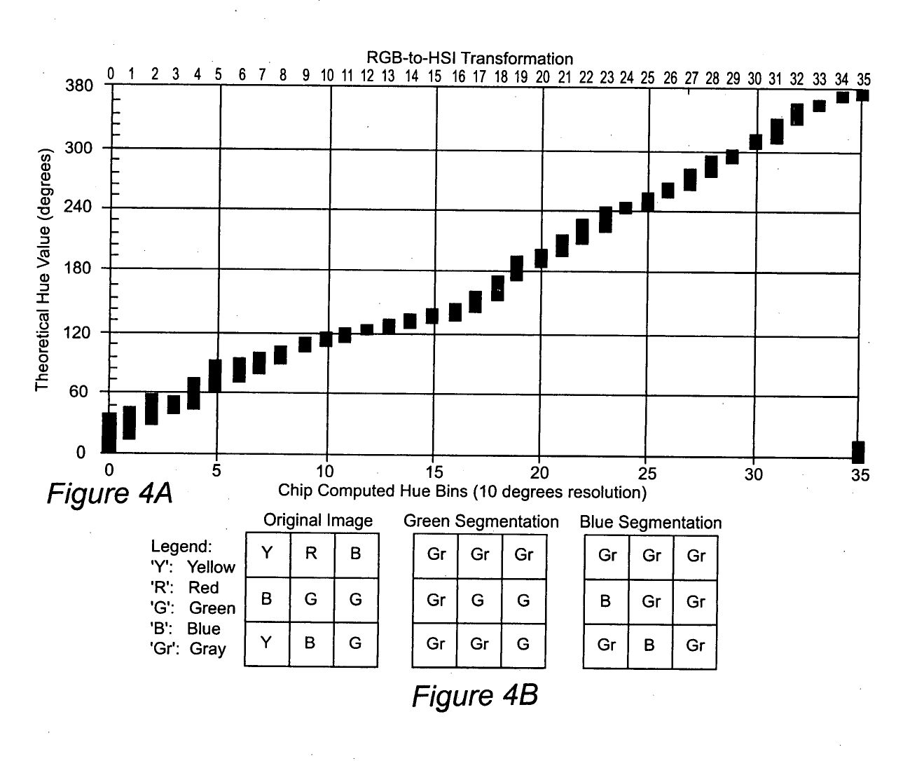

The Imager: In the imager array 20, three currents, corresponding to R, G and B, values are sampled-and-held for each pixel (a color filter wheel is used in this prototype). To facilitate processing, a current mode imaging approach is adopted. This approach provides more than 120 dB of dynamic range as noted in “Sensitive Electronic Photoreceptor”, cited above, allows RGB scaling for white correction using a multiplying DAC, and RGB normalization using a translinear circuit as described in “Translinear Circuits, 25 Years on Part I, The Foundations” by B. Gilbert, Electronic Engineering (London), Vol. 65, No. 800, August, 1993. The normalization guarantees that a large dynamic range of RGB currents are resized for the HSI or other color space transformer, if used, to operate robustly. However, if used, normalization and/or color space transformation limits the speed of operation to approximately 30 fps because the transistors must operate in sub-threshold regions. For read-out, the pixels can be grouped into blocks of 1×1 (single pixel) to 128×64 (entire array). The blocks can be advanced across the array in single or multiple pixel intervals. The organization of the pixels and the scanning methods are programmable by loading bit patterns in two scanning registers for each coordinate direction, one (12, 18) for scanning pixels within blocks and the other (14, 16) for scanning the blocks across the array. FIGS. 2A and 2B shows the schematic of the pixel and a portion of the RGB normalizer, respectively. FIG. 5A shows a representation of a sample image. The output currents of the pixel are amplified using tilted (e.g. having different voltage power supplies for the input and output) current mirror circuits as shown in FIG. 2A, where Vdd d<Vdd m. The reset switch 210 is included to accelerate the off-transition of the pixel. Not shown in FIG. 2B is the scaling circuit, which simply multiplies the RGB components by programmable integer coefficients from 1-16. The image represented in FIG. 5A has been white corrected using the scaling circuit and shows the mismatch that is typical for current mode imagers.

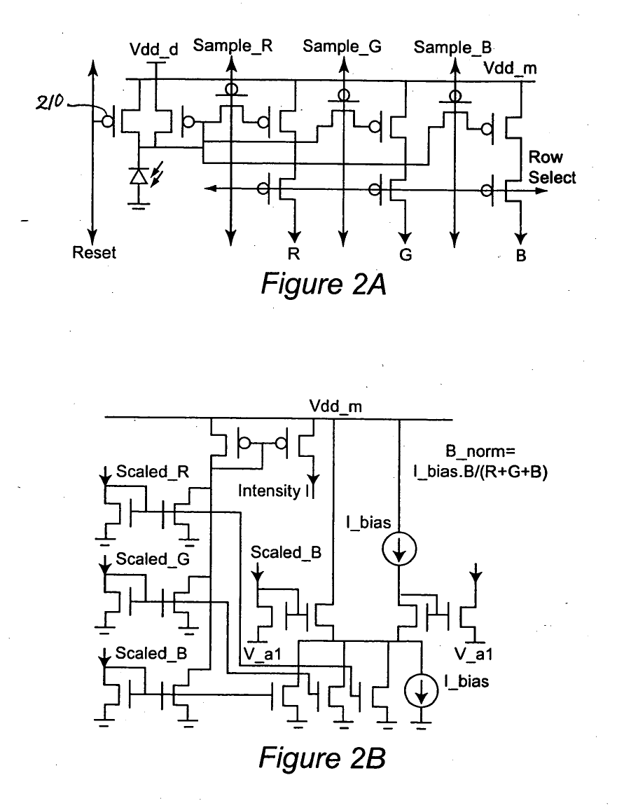

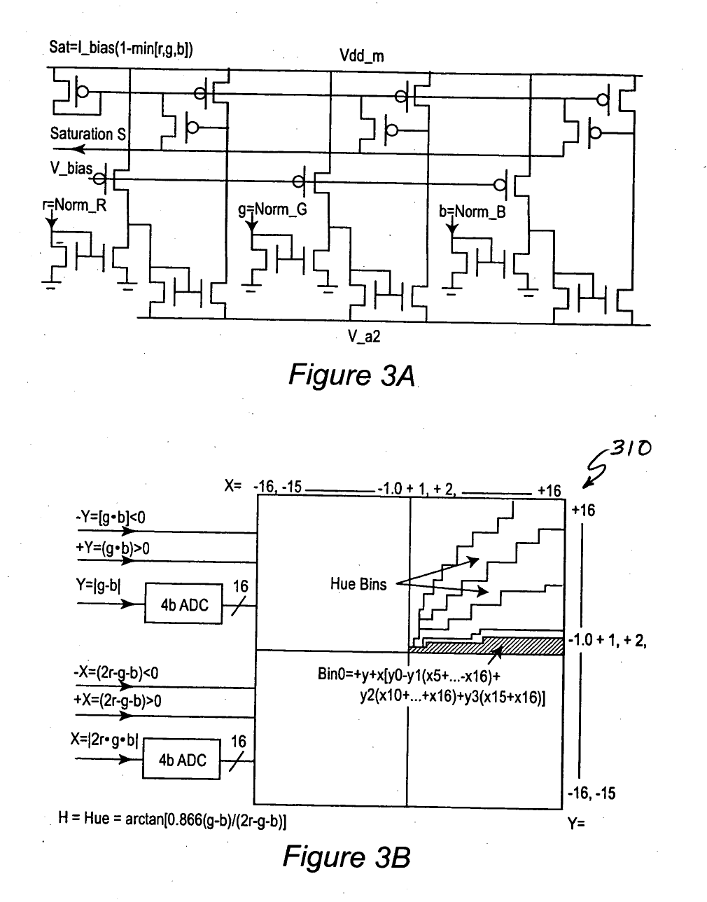

RGB-to-HSI and Color Segmentation: The preferred RGB-to-HSI transformer 20 uses an opponent color formulation, reminiscent of biological color processing as discussed in the Gilbert article, cited above. The intensity (I) is obtained before normalization by summing the RGB components (see FIG. 2B). Saturation (S) is computed by subtracting the minimum of the normalized RGB values from the sum. Hue (H) is given by the arctan[0.866*(g−b)/(2r−g−b)], where rbg are the normalized RGB values as discussed in “Digital Image Processing, by R. Gonzalez et al., Addison-Wesley Publishing Co, 1992. Due to the complexity of computing this function, an analog look-up table is used. A hybrid circuit 22 that simply correlates (g−b) and (2r−g−b) and indicates which Hue interval corresponds to the RGB values is adequate for successful practice of the invention and, especially in the rule-based embodiment described below, supports the meritorious function of improved illumination color temperature insensitivity. The (g−b) and (2r−g−b) components are each quantized into 16 levels using a thermometer code 4 bit analog to-digital conversion. The look-up table maps the 18×18 (the quadrant is given by the signs of the components) input combinations into 36 Hue intervals, each having 10 degrees resolution, to cover the 360 degrees of Hue space. The HSI computation is applied to each RGB value scanned from the array; color segmentation is realized by testing each pixel's HSI values against prescribed values, and the appropriate label is applied to the pixel. FIG. 3A shows the schematic of the Saturation and Hue computation circuits. A loser-take-all circuit is used to find the minimum rgb component for the Saturation (S) value. The mapping of rgb values in Hue bins 310 uses a ROM decoder. FIG. 4A shows the measured relationship between input Hue angle and bin allocation. The plot is obtained by presenting known values of RGB (i.e. Hue angle) to the chip and recording the Hue bins that are triggered. There are some overlaps in the response ranges of the individual bins because of analog imprecision in creating the Hue table's input addresses. Notice, however, that the overlaps are desirably restricted to nearest neighbor bins. Also shown in FIG. 4B is the pixel color segmentation result for a test image of a Rubik's cube. To test the processing unit in isolation, an external image was used. The Figure shows that the chip clusters parts of the image with similar HSI components into similar bins.

HSI Histogramming and Template Matching: The HSI histogramming step is preferably performed using 36, 12-bit counters to measure the number of pixels that fall within each prescribed HSI interval. The number of histogram intervals is not critical to the practice of the invention but approximately 30 to 36 intervals is preferred to yield adequate color resolution while limiting errors due to illumination spectrum induced color shifts and suitably limiting space requirements on the chip. It should also be understood that histogramming is not necessary to the successful practice of the invention and that other computational expedients such as a vector could be used. Nevertheless histogramming has been found to be convenient in regard to computation, signature coding and required chip space. After the scanning of the imager is completed, the counters hold the color signature of the scene. During the learning phase, the signature is transferred to one of the 32 on-chip array of SRAM template cells. During the matching phase, the newly acquired signatures are compared to the stored templates, using 8 serial presentations of 4 parallel templates, with the SAD cells. The resultant error for each template is presented to logic for selecting the best match, either on or off the chip, where they can be sorted using a simple micro-controller such as a PIC, to find the best match template. FIG. 5A shows an example of template matching, where the color signature of parts of cans are “learned” and subsequently localized in a scene containing multiple cans. The learned segment is 15×15; during matching, the image is scanned in blocks of 15×15, shifted by 8 pixels. No scanned block matches the learned block exactly. A plot of the SAD error is also shown in FIG. 5B. Match threshold is set to 155.

The prototype of the arrangement described above demonstrates that a real-time color segmentation and recognition system can be implemented using a small silicon area and small power budget. By using a fabrication technology with RGB filters, the entire system can be realized with a tiny footprint for compact imaging/processing applications. The above arrangement using RGB-to-HSI conversion is preferred since it is believed that signals corresponding to colors in the HSI color space most closely models human color perception sensitivity. However, it has been found that the invention can be successfully practiced using signals corresponding to any color space (e.g. CMY, YIG, RGB, etc.) and that color space conversion is unnecessary to the practice of the invention. In other words, the invention, in a generalized form, need not rely on specific computations but may be implemented in a rule-based form which is as robust as the preferred embodiment described above, if not more so, as well as enhancing stability under conditions of variable color temperature of illumination. The more general form of the invention can be integrated even more easily on a single chip since color space conversion is not necessary: leaving additional chip space for a more extensive imager array (although high spatial resolution is not necessary for obtaining color signatures of identifiable objects) and/or storage of a greater number of templates to support recognition, tracking and the like of a larger number of objects. On the other hand, if desired, any desired color space conversion can be provided, allowing greater flexibility in data capture in accordance with any desired color space as well as allowing exploitation of particular properties of particular color spaces such as more linear processing for noise removal, simplicity of computations of opponent color values, modeling of biological systems and the like. As with the preferred hue-based embodiment described above, special-purpose gate arrays and circuits can be provided for relatively simple calculations and any complex calculations can be approximated sufficiently for histogramming, vector computation and the like with a suitable degree of color resolution, as discussed above, by using a look-up table in a manner similar to that used for RGB-to-HSI conversion, as also discussed above.

Specifically, a rule-based embodiment of the invention is preferably implemented with processing which falls into two groups: a.) preprocessing and normalization and b.) rule application. Basically, the preprocessing and normalization captures image data, standardizes the form of the data and determines color opponencies. The application of rule sets develops color families and then refines the color categorization into sub-families and then analyzes the amount of variation in data within a sub-family to develop a color signature for learning or recognition of objects/scene segments in newly captured data.

As with the preferred, hue-based embodiment described above, the raw data sampling can be performed in numerous ways such as using a color filter wheel in the optical system projecting a scene on the image sensor or the scene can be illuminated with alternating wavelengths of light. Color filters or differences in color sensitivity can also be implemented on the chip but such alternatives generally cause substantial increases in cost and chip space (since plural pixel areas are then required for respective colors of an elemental area of a scene). Illumination or sensing in at least three wavelength bands covering the spectral region of interest is preferred. The light incident on the imager array is measured/quantized and an N-dimensional vector (where N equals the number of spectral bands measured) is produced. These measurements are then normalized. A chart with black, white and three intervening gray levels such as the commercially available Macbeth Color Checker Chart, commonly used in color photographic printing, has been found to provide convenience in normalization. It is preferred to normalize image values such that the value of each element is between zero and one in each color band measured. Once normalization has been accomplished, color opponencies are determined.

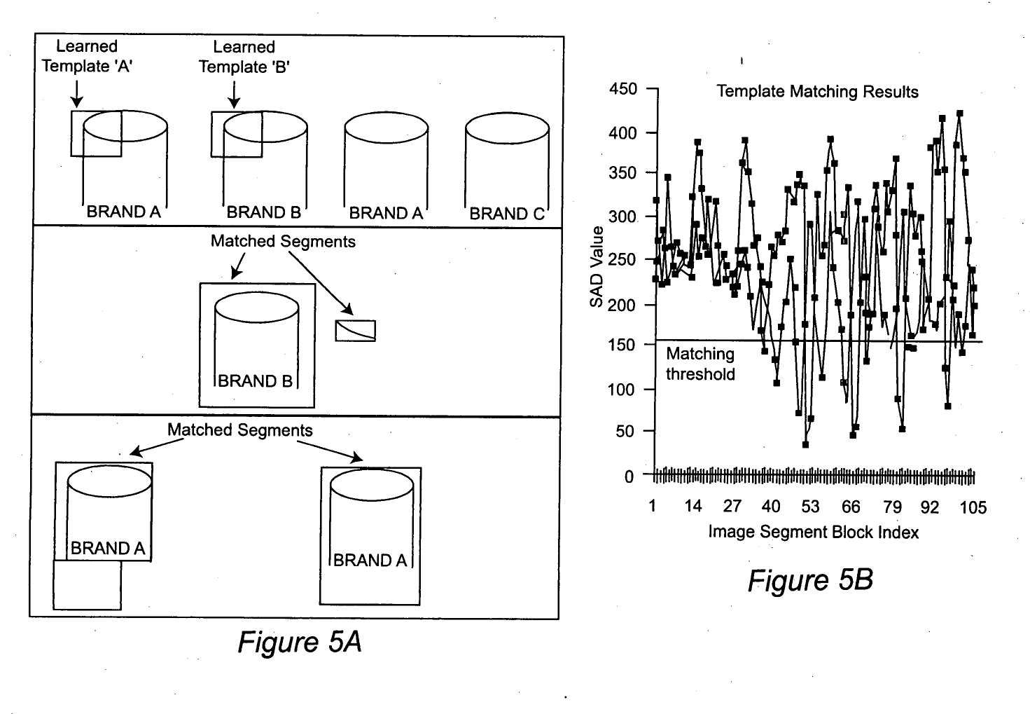

The concept of color opponencies is important to the practice of the generalized form of the invention as it is in the preferred embodiment. Color opponencies, as the term suggests, represent the basic distinctions which are made between colors or color component values in order to develop at least three color channels to which rule sets can later be applied. In theory, color opponencies may be freely chosen but careful selection of color opponencies can greatly improve color error tolerance (e.g. a misidentification of a color between purple and blue is much more tolerable in terms of extracting a color signature of a portion of a scene than a gross error such as between yellow and blue—therefore color opponencies should preferably be defined between colors which are most nearly opposite and the opponencies chosen should be as nearly orthogonal as possible as shown in FIG. 6) and may also provide simplification of computations and processing, particularly if a conversion between color spaces is used, as in the preferred embodiment. Each opponency may be considered as a vector extending between substantially opposite colors and each imaged color will represent a point along each opponency vector and thus may also be characterized as a vector, as well. In general, as a matter of convention as well as convenience, opponencies should also be defined in terms of components of a particular color space. For example, in an RGB color space an exact opponency to red should be defined as blue-green rather than cyan so that (or since) color values in accordance with a single consistent color space and which are directly available may be directly used in the computations for rule set applications and eventual segmentation and signature determination. However, substantial orthogonality of opponencies is more important than the particular colors chosen for each opponency and the concept of opponency should be understood to comprehend transformations which yield at least three data channels which, together, are capable of characterizing and encoding a color. By the same token, color opponencies may be defined in a manner which may correct or mitigate a color imbalance in the imager which is not correctable by normalization as discussed above.

Three or more sets of color opponencies are preferred for practice of the invention but three sets of color opponencies are also entirely sufficient for successful practice of the invention. It is also preferred that one of the opponencies be a black-white opponency. Exemplary opponencies for some commonly used color spaces are:

for RGB, red-green (=R−G), blue-yellow (=2*B−R−G), and black-white (=(R+B+G)/3);

for CMY, an M−C channel is equivalent to the R−G channel in an RGB system (and the equivalency appears as the R−G and M−C opponcencies being parallel vectors in FIG. 6); blue-yellow (=C+M−2Y) and black-white (=1−(C+M+Y))/3);

for YIQ, the YIQ is simply RGB multiplied by a suitable 3×3 matrix; etc. In general, good choices of color opponencies will allow distinctions between colors to be made in accordance with each opponency by analog differential amplifiers or by relatively simple (and small chip area) digital addition, subtraction and multiplication and division by two and three circuits, suitable forms of which are known in the art. It should be noted from the above examples, that good choices for color opponencies are often somewhat similar due to the desirability of substantial mutual orthogonality of opponencies (e.g. as depicted in FIG. 6) regardless of the color space in terms of which they are defined (e.g. a blue-yellow equivalent and a red-green or cyan-magenta equivalent will often be a favorable choice to minimize gross errors and simplify processing), indicating the true generality of the rule-based generalized embodiment of the invention. It should also be appreciated that such transformations from the sensor output color space to selected opponencies largely mimics the generally accepted theory of the mechanism of human visual perception.

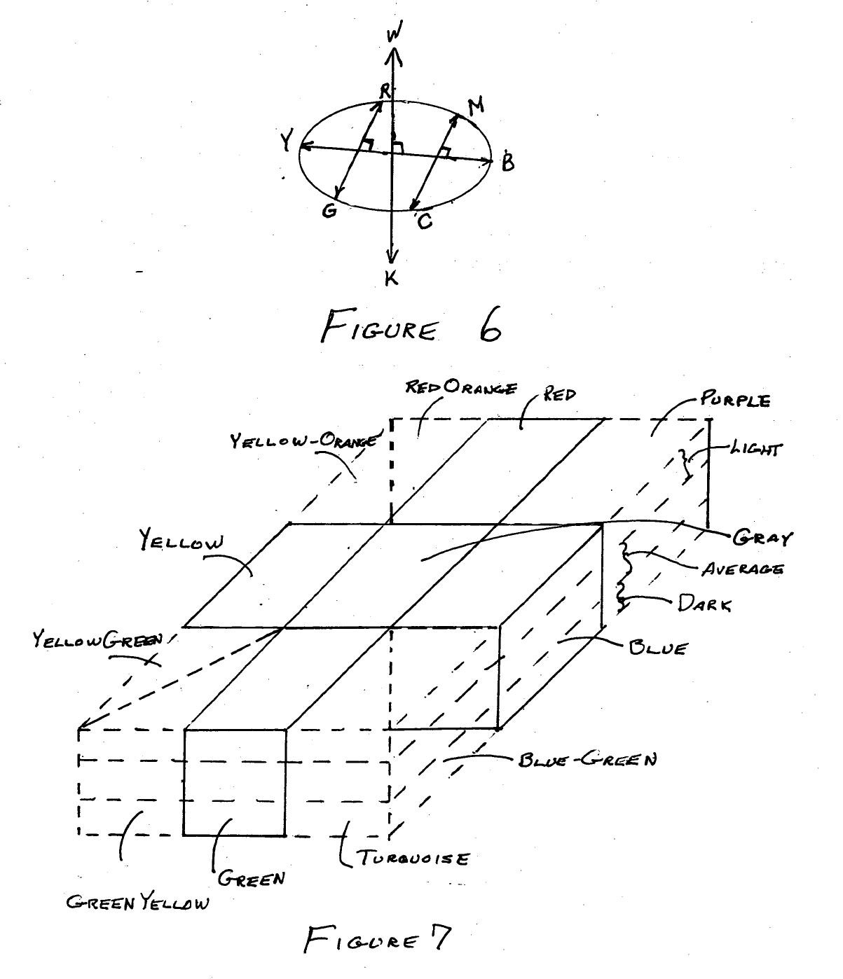

Once the captured raw data has been transformed in terms of defined opponencies three preferred rule sets can be applied in turn. The first rule set applied classifies the transformed data into families such as red, green, blue, yellow and gray (which may be visualized as five volumes arranged in a cruciform configuration as shown in solid lines of FIG. 7) and is performed by examination of the respective opponent vectors. For example, if blue minus yellow>0 and blue minus yellow>|red-green| (where | . . . | indicates the absolute value function), then blue is the dominant color family of the data. These comparisons can be made using simple digital or analog circuits similar to those discussed above in regard to the preferred, hue-based embodiment of the invention.

The second rule set develops sub-families to characterize the relative color vector lengths along the respective opponencies. For example, a color which could be described as orange could, depending on the particular shade thereof, be classified into either a red or yellow family which correspond to different opponencies. Application of this second rule set determines if the color is a red-orange or a yellow orange. The sub-families can be visualized as bifurcated volumes (depicted with dashed lines) in the interstices or corners between arms of the cruciform arrangement of volumes in FIG. 7. It should be noted that the volume corresponding to purple is not divided since purple, being a mixture of widely separated wavelengths, is a special case and is treated differently for purposes of its contribution to a color signature. It should also be noted that application of the second rule set results in eleven classes (e.g. families and sub-families) plus gray while, culturally, eleven different terms (black, white, gray red, green blue, yellow, pink orange purple and brown with some cultures having a name for blue-green as well; pink being a lighter division of red and brown being a darker division of brown while white and black are substantially extreme shades of gray) are predominantly used to describe particular colors in most of the world's languages. Thus the invention appears to be largely consistent with human visual perceptions of the distinctions between colors and comparably robust and stable in regard to color discrimination under conditions of differing color temperature of illumination light. More or fewer families and sub-families may be provided but the number described above is preferred as appearing to most closely mimic human color discrimination while being of a complexity which is easily accommodated on a single chip with other elements described above.

Application of the third rule set analyzes the amount of variation in the respective color channels corresponding to the opponencies discussed above. Low variation corresponds to de-saturated colors which are identified as “light” while wide variation corresponds to saturated colors. Low luminosity colors are referred to as “dark”. While the definitions of light and dark are not entirely symmetric, results have, nevertheless, been found to be quite acceptable. Average variation is also discriminated which, together with light and dark classifications, provides a multiplication of the families and sub-families by a factor of three (e.g. dark, average and light—more subdivisions of families and sub-families may be provided if desired), generally corresponding to the preferred thirty-six bins of the histogram described above in connection with the preferred, hue-based embodiment of the invention and can thus clearly be accommodated by the chip in accordance with the invention as described above in connection with the hue-based preferred embodiment.

In view of the above discussion of the preferred hue-based embodiment of the invention and the rule-based, generalized implementation of the invention, those skilled in the art will recognize that the pre-processing followed by application of the first and second rule sets is comparable to and serves much the same function as the hue computer of the preferred embodiment but does not require (but can include) a color space transformation while being generalized to any color space and application of the first rule set followed by application of the third rule set is comparable to the saturation computation in the preferred, hue-based embodiment. Accordingly, it is seen that a generalized, rule-based embodiment of the invention is broadly applicable to any arbitrary color space, is robust and stable in practice under varying illumination conditions, does not require a color space conversion and processing circuitry is at least as well accommodated, together with an imager array, on a single integrated circuit chip.

While the invention has been described in terms of several embodiments and approaches, those skilled in the art will recognize that the invention can be practiced with modification within the spirit and scope of the appended claims.

1. A color-based visual sensor, comprising
means for sensing component colors of light in a scene and providing image data in accordance with an arbitrary color space,
means for defining opponencies in said color space,
means for transforming said image data in accordance with said opponencies to provide transformed image data,
means for dividing said transformed image data into families and sub-families in accordance with respective opponencies and combinations of opponencies, respectively, and dividing said families and subfamilies in accordance with variation of said transformed image data corresponding to respective opponencies to produce divided transformed image data,
means for region of interest selection,
means for analyzing said divided transformed image data over said region of interest to develop a color signature, and
means for matching said color signature with a template.

2. A sensor as recited in claim 1, wherein said means for analyzing said divided transformed image data includes means for histogramming said divided transformed image data corresponding to respective pixels in said region of interest.

3. A sensor as recited in claim 2, wherein said means for histogramming includes a plurality of counters.

4. A sensor as recited in claim 3, wherein said plurality of counters comprises thirty-six counters.

5. A sensor as recited in claim 1, wherein said arbitrary color space is and RGB color space.

6. A sensor as recited in claim 1, wherein said arbitrary color space is and CMY color space.

7. A sensor as recited in claim 1, wherein said arbitrary color space is and YIQ color space.

8. A sensor as recited in claim 1, further including
means for transforming data of said arbitrary color space into data of another color space.

9. A sensor as recited in claim 1, wherein said means for transforming said image data in accordance with said opponencies includes a look-up table for approximating transformed data values.

10. A sensor as recited in claim 1, wherein dimensions of said region of interest are variable.

11. A sensor as recited in claim 1, including means for scanning a region of interest over pixels of said means for sensing component colors of light.

12. A sensor as recited in claim 1, further including
means for normalizing said image data.
